(19) United States
(12) Patent Application Publication
(10) Pub. No.: US 2025/0165650 A1
(43) Pub. Date: May 22, 2025

(54) SYSTEM AND METHOD FOR PERFORMING ARTIFICIAL INTELLIGENCE GOVERNANCE

(71) Applicant: Polygraf Inc., Georgetown, TX (US)

(72) Inventors: Yagub RAHIMOV, Georgetown, TX (US); Vignesh KARUMBAYA, Oak Park, IL (US); Toghrul TAHIROV, Baku (AZ); Vusal SHAHBAZZADE, Sumqayit (AZ); Yusif MUKHTAROV, Baku (AZ)

(21) Appl. No.: 18/951,413

(22) Filed: Nov. 18, 2024

Related U.S. Application Data
(60) Provisional application No. 63/600,444, filed on Nov. 17, 2023.

(51) Int. Cl. G06F 21/62

(52) U.S. Cl. CPC G06F 21/6254

(57) ABSTRACT

A method for identifying and anonymizing confidential information in input data where the method is performed by at least one computer processor executing computer-readable instructions tangibly stored on at least one computer-readable medium. The method includes extracting one or more of textual data and document data from the input data, wherein the document data includes one or more of second textual data and image data, processing the textual data and the second textual data to identify the confidential information therein, anonymizing the confidential information, processing the image data to identify image-based confidential information therein, and anonymizing the image-based confidential information.

### RELATED APPLICATION

The present application claims priority to U.S. provisional patent application Ser. No. 63/600,444, filed on Nov. 17, 2023, entitled SYSTEM AND METHOD FOR PERFORMING ARTIFICIAL INTELLIGENCE GOVERNANCE, the contents of which are herein incorporated by reference.

### BACKGROUND OF THE INVENTION

The present invention relates to systems and methods for processing and handling confidential information, and more specifically relates to systems and methods for identifying and masking the confidential information.

Modern data networks and associated systems employ machine learning models to process data and can employ systems and techniques for governing the dissemination of confidential data. Conventional systems typically employ data networks that connect with servers and networks outside of the enterprise network, and as such are not deemed to be truly local networks (e.g., on premises).

Conventional systems and methods also exist for identifying confidential information resident in the system networks and typically involves a combination of manual and automated techniques. The conventional techniques can be configured to detect and protect confidential data from unauthorized access, disclosure, or manipulation. The conventional systems can employ data access and classification policies and procedures that categorize the data based on the sensitivity of the data. The computer networks can also employ automated data monitoring techniques that analyze the network data in an effort to determine if unauthorized system activity is occurring.

A drawback of these conventional systems and methods is that they are time and resource intensive, and the systems are not guaranteed to detect and protect all of the necessary confidential information resident within the system.

### SUMMARY OF THE INVENTION

The governance system of the present invention addresses the challenges of identifying and securing confidential information in any type of data processing system that is responsible for processing any type of textual information and the commonly utilized file types by providing a comprehensive artificial intelligence enabled governance framework. The present invention can process text data and document data, which include image data, and then detect or identify the confidential information that may reside or be present within the data. The governance system can then selectively anonymize the data to mask, obscure, or highlight the data for a user. The governance system can employ optimized machine learning models that reduce the reliance on system resources and processes the data in a resource efficient manner.

The present invention is directed to a computer-implemented method for identifying and anonymizing confidential information in input data where the method is performed by at least one computer processor executing computer-readable instructions tangibly stored on at least one computer-readable medium. The method includes extracting one or more of textual data and document data from the input data, wherein the document data includes one or more of second textual data and image data, processing the textual data and the second textual data to identify the confidential information therein, anonymizing the confidential information, processing the image data to identify image-based confidential information therein, and anonymizing the image-based confidential information.

The step of extracting the data comprises determining whether the textual data or the document data forms part of the input data and parsing with a parsing engine the document data into the second textual data and the image data. The step of processing the textual data and the document data includes detecting and identifying the confidential information in the textual data and the second textual data and anonymizing the confidential information. According to one embodiment, the confidential information can include identifiable confidential information and contextually hidden confidential information. As such, the step of detecting and identifying can include applying a first machine learning model to the confidential information to identify the identifiable confidential information and applying a second machine learning model to the textual data and the second textual data for identifying the contextually hidden confidential information therein. The second machine learning model can generate second model data that includes the contextually hidden confidential information. The step of detecting can further include applying a hierarchical recursive segment analysis technique to the second model data for identifying in the contextually hidden confidential information data that contributes the most to the decisions of the second machine learning model.

The step of anonymizing the confidential information can include applying a third machine learning model to the confidential information to anonymize the confidential information. The third machine learning model can include a named entity recognition (NER) model, a regular expression (Regex) model, or a text classification model. Further, the step of anonymizing can include highlighting the confidential information.

The step of processing the image data can include processing the image data with an optical character recognition engine for extracting third textual data from the image data and identifying confidential information therein. The step of processing the image data can also include detecting fingerprint data in the image data and/or detecting signature data in the image data. The signature data and the fingerprint data can form part of the image-based confidential information. The step of anonymizing the image-based confidential information can include redacting the image-based confidential information and anonymizing the confidential information or the image-based confidential information by replacing one or more portions thereof with synthetic data.

The present invention is also directed to a system for identifying and anonymizing confidential information in input data. The system can include a data extraction unit for extracting one or more of the textual data and the document data from the input data, where the document data includes one or more of second textual data and image data. The data extraction unit can include a determination unit for determining whether the textual data or the document data forms part of the input data, and a parsing unit having a parsing engine for parsing the document data into the second textual data and the image data. The system further includes a text processing unit having a text processing engine for processing one or more of the textual data and the second textual data and for identifying confidential information therein and for anonymizing the confidential information. The text processing unit can include a confidential information detection unit employing a first machine learning model configured for detecting and identifying confidential information in the textual data and the second textual data, where the confidential information includes identifiable confidential information and contextually hidden confidential information, and an anonymization unit for selectively anonymizing the confidential information. The system further includes an image processing unit for processing the image data and for identifying image-based confidential information therein.

The first machine learning model can include a transformer-type model, such as a natural language processing model. The confidential information detection unit can apply a second machine learning model to the textual data and the second textual data for identifying the contextually hidden confidential information therein. The second machine learning model can generate second model data that includes the contextually hidden confidential information. The confidential information detection unit further applies a hierarchical recursive segment analysis (HRSA) technique to the second model data for identifying in the contextually hidden confidential information data that contributes the most to the decisions of the second machine learning model.

The image processing unit includes a text recognition unit employing an optical character recognition engine for extracting third textual data from the image data, and then processing the third textual data with the confidential information detection unit to identify confidential information in the third textual data. The image processing unit can further include a fingerprint detection unit for detecting fingerprint data in the image data and/or a signature detection unit for detecting signature data in the image data. The signature data and the fingerprint data form part of the image-based confidential information. The system can further include a redaction unit for anonymizing the image-based confidential information, and the redaction unit can be configured to redact the image-based confidential information. Further, the anonymization unit or the redaction unit can be configured to replace at least portions of the confidential information and the image-based confidential information with synthetic data.

The present invention is further directed to a non-transitory, computer readable medium comprising computer program instructions tangibly stored on the computer readable medium, wherein the computer program instructions are executable by at least one computer processor to perform a method for anonymizing confidential information in input data. The method can include extracting one or more of textual data and document data from the input data, wherein the document data includes one or more of second textual data and image data, including determining whether the textual data or the document data forms part of the input data, and parsing with a parsing engine the document data into the second textual data and the image data. The method also includes processing the textual data and the second textual data to identify the confidential information therein, including detecting and identifying, with a transformer-type machine learning model, the confidential information in the textual data and the second textual data, and anonymizing the confidential information. The method further includes processing the image data to identify image-based confidential information therein, and anonymizing the image-based confidential information.

The confidential information can include identifiable confidential information and contextually hidden confidential information. As such, the step of detecting and identifying can include applying a first machine learning model to the confidential information in the textual data and the second textual data for identifying the identifiable confidential information therein, applying a second machine learning model to the textual data and the second textual data for identifying the contextually hidden confidential information therein where the second machine learning model generates second model data that includes the contextually hidden confidential information, and applying a hierarchical recursive segment analysis technique to the second model data for identifying in the contextually hidden confidential information data that contributes the most to the decisions of the second machine learning model.

The computer readable medium also employs a method for anonymizing the confidential information includes applying a third machine learning model to the confidential information to anonymize the confidential information. The third machine learning model includes a named entity recognition (NER) model, a regular expression (Regex) model, or a text classification model. Further, anonymizing the confidential information can include highlighting the confidential information. Further, processing the image data can include processing the image data with an optical character recognition engine for extracting third textual data from the image data and identifying confidential information therein. Still further, processing the image data also includes detecting fingerprint data in the image data and/or detecting signature data in the image data. The signature data and the fingerprint data form part of the image-based confidential information.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principles of the invention and, although not to scale, show relative dimensions.

FIG. 1 is a data flow diagram showing a user ability to interact with a governance system of the present invention via a network.

FIG. 2 is a schematic depiction of the governance system of the present invention.

FIG. 3 is a schematic depiction of the confidential information detection unit of FIG. 2 according to the teachings of the present invention.

FIG. 4 is a schematic block diagram of another embodiment of the governance unit according to the teachings of the present invention.

FIG. 5 is a schematic block diagram of the text processing unit of the governance system of FIG. 4 according to the teachings of the present invention.

FIG. 6 is a schematic block diagram of the image processing unit of the governance system of FIG. 4 according to the teachings of the present invention.

FIG. 7 is a schematic flow chart diagram illustrating the data flow in the governance system of FIG. 4 according to the teachings of the present invention.

FIGS. 8A and 8B are schematic flow chart diagrams of the data flow within an HRSA model employed by the confidential information detection unit of the governance system of FIG. 4 according to the teachings of the present invention.

FIG. 9 is a schematic block diagram of exemplary hardware, such as an electronic device, suitable for implementing one or more components of the governance systems of FIGS. 1 and 4 according to the teachings of the present invention.

### DETAILED DESCRIPTION OF THE INVENTION

As used herein, the term “enterprise” is intended to include all or a portion of a company, a structure or a collection of structures, facility, business, company, firm, venture, joint venture, partnership, operation, organization, concern, establishment, consortium, cooperative, franchise, or group or any size. Further, the term is intended to include an individual or group of individuals, or a device or equipment of any type.

As used herein, the term “confidential information” is intended to include any type of sensitive and confidential information that requires or would benefit from being protected from purposeful or accidental dissemination or disclosure. The information can include personally identifiable confidential information, payment card history information, personal health data, proprietary code data, business-related information, health data, financial data, and the like. The personally identifiable information is information that can be used to identify an individual or a group of individuals or an enterprise. Examples of suitable personally identifiable information can include name, address, phone number, social security number (SSN), information, passport information, signature, health related information, biometric related information including fingerprint data, financial information, sensitive personal information, and the like. The sensitive personal information can refer to personal information that is considered particularly private and if disclosed can result in harm to the individual. This type of information can include, in addition to the above, sexual orientation information, race and ethnicity related information, religious information, political information, legal related information including criminal history information, and the like. The payment card history information refers to an individual or an enterprise's history of using payments cards, such as credit and debit cards, information related to transactions, account balances, and other related data, credit limit information, merchant information, and the like. The personal health information can refer to health related data associated with an individual. The proprietary software code information can refer to software code or applications that are owned by a particular individual or enterprise and are not freely available. The business-related information can refer to important information associated with the operation, governance, sales, and finances of a business. Examples of types of business information an include product and services sales information, customer information, marketing information, enterprise operational information, intellectual property related information, legal and regulatory information, technology infrastructure information, and the like.

As used herein, the term “financial data” can include any data that is associated with or contains financial or financial related information. The financial information can include information that is presented free form or in tabular formats and is related to data associated with financial, monetary, or pecuniary interests. Further, as used herein, the term “non-financial data” is intended to include all data, including if appropriate environmental data, that is not financial data as defined herein.

As used herein, the term “health data” or “health-related data” includes any type of data related to the scheduling, delivery, and application of healthcare related services to a person, such as a patient, and to healthcare related claims and associated billing information. Examples of suitable types of data include patient encounter data (e.g., appointment data and schedule data), medical data, registration data, demographic data, psychological and mental related data, medication related data, radiological data, test and laboratory result data, dental related data, disease related data, medical provider data including the type of healthcare provider, prescription data, immunization data, genetics related data, body measurement related data (e.g., height, weight, blood pressure, and the like), referral related data, climate and pollution or emission related data, insurance related data, billing data, information created or generated by healthcare professionals, data from monitoring devices such as wearable and non-wearable devices, revenue data associated with the delivery of health services, and the like. The health-related data can be provided in any selected form or format and can be stored in any type of storage medium and format and is typically provided as part of an electronic health record.

As used herein, the term “machine learning” or “machine learning model” or “model” is intended to mean the application of one or more software application techniques that process and analyze data to draw inferences and/or recommendations from patterns in the data. The machine learning techniques can include a variety of artificial intelligence (AI) and machine learning (ML) models or algorithms, including supervised learning techniques, unsupervised learning techniques, reinforcement learning techniques, knowledge-based learning techniques, natural-language-based learning techniques such as natural language generation and natural language processing models including generative language models, deep learning techniques, and the like. The machine learning techniques are trained using training data. The training data is used to modify and fine-tune any weights associated with hyperparameters of the machine learning models, as well as record ground truth for where correct answers can be found within the data. As such, the better the training data, the more accurate and effective the machine learning model can be. The supervised learning models are trained on labeled datasets to learn to map input data to desired output labels. This type of learning model can involve tasks like classification and regression. The unsupervised learning model involves models that analyze and identify patterns in unlabeled data. Clustering and dimensionality reduction are common tasks in unsupervised learning. The semi-supervised learning models combine elements of both supervised and unsupervised learning models, utilizing limited labeled data alongside larger amounts of unlabeled data to improve model performance. The reinforcement learning model involves training models to make sequential decisions by interacting with a selected environment. The models learn through trial and error, receiving feedback in the form of rewards or penalties. The deep learning model utilizes neural networks with multiple layers to automatically learn hierarchical features from data. The neural networks can include interconnected nodes, or “neurons,” organized into layers. Each connection between neurons is assigned a weight that determines the strength of the signal being transmitted. By adjusting these weights based on input data and desired outcomes, neural networks can learn complex patterns and relationships within the data. The neural networks can include feedforward neural networks (FNNs), convolutional neural networks (CNNs), recurrent neural networks (RNNs), long short-term memory (LSTM) networks, gated recurrent units (GRUs), autoencoders, generative adversarial networks (GANs), transformers, and large language models (LLMs). The large language models can be configured to understand and generate human language by learning patterns and relationships from vast amounts of data. The LLMs can utilize deep learning techniques, particularly transformer architectures, to process and generate text. These models can be pre-trained on massive data corpora (e.g., text corpora) and can perform tasks such as text generation, language translation, text summarization, sentiment analysis, and the like. The LLMs can include generative artificial intelligence (AI) models.

The transfer learning model can involve training a model on one task and transferring its learned knowledge to a related task, often enhancing efficiency and performance. The ensemble learning model can combine multiple models to make more accurate predictions. Common techniques include bagging and boosting. The online learning model can be updated continuously as new data becomes available, making them suitable for dynamic environments. The instance-based learning model can make predictions based on the similarity between new instances and instances in the training data.

The machine-learning processes as described herein may be used to generate machine-learning models. A machine-learning model, as used herein, is a mathematical representation of a relationship between inputs and outputs, as generated using any machine-learning process including without limitation any process as described above and stored in memory. An input can be submitted to a machine-learning model once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model may be generated by creating an artificial neural network, such as a convolutional neural network comprising an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

As used herein, the term “generative model,” “generative AI model” or “generative language model” is intended to refer to a category of machine learning models that generate new outputs based on data on which the model has been trained. Unlike traditional models that are designed to recognize patterns in the input data and make predictions based thereon, the generative language models generate new content in the form of images, text, audio, hieroglyphics, code, simulations, and the like. The language models are typically based on large language models (LLMs) or deep learning neural networks, which can learn to recognize patterns in the data and generate new data based on the identified patterns. The language models can be trained with training data on a variety of data types, including text, images, and audio, and can be used for a wide range of applications, including image and video synthesis, natural language processing, music composition, and the like. Typically, generative language models can employ a type of deep learning model called a generative adversarial network (GAN) that includes two neural networks that work together to generate new data. The generative language model can also optionally employ recurrent neural networks (RNNs), which are a type of neural network that is often used for natural language processing tasks. The RNNs are able to generate new text by predicting the likelihood of each word given the context of the previous words in the sentence. The generative AI model can also optionally employ a transformer model, which is a type of neural network architecture that is often used for language modeling tasks. The transformer model is able to generate new text by attending to different parts of the input text prompt and learning the relationships between the parts. Variational autoencoders (VAEs) can also be used and are a type of generative language model that learns to represent the underlying structure of a dataset in a lower-dimensional latent space. The model then generates new data points by sampling from this latent space. Deep convolutional generative adversarial networks (DCGANs) can also be employed and are a type of GAN that uses convolutional neural networks to generate realistic images. The DCGAN model is commonly used for image synthesis tasks, such as generating new photos or realistic textures.

In the present disclosure, data used to train a machine learning model can include data containing correlations that a machine-learning process or technique may use to model relationships between two or more types or categories of data elements (“training data”). For instance, and without limitation, the training data may include a plurality of data entries, each entry representing a set of data elements that were recorded, received, and/or generated together. The data elements may be correlated by shared existence in a given data entry, by proximity in a given data entry, or the like. Multiple data entries in the training data may evince one or more trends in correlations between categories or types of data elements. For instance, and without limitation, a higher value of a first data element belonging to a first category or other types of data that may tend to correlate to a higher value of a second data element belonging to a second category or type of data element, indicating a possible proportional or other mathematical relationship linking values belonging to the two categories. Multiple categories of data elements may be related in training data according to various correlations, and the correlations may indicate causative and/or predictive links between categories of data elements, which may be modeled as relationships such as mathematical relationships by the machine-learning processes as described herein. The training data may be formatted and/or organized by categories of data elements, for example by associating data elements with one or more descriptors corresponding to categories of data elements. As a non-limiting example, training data may include data entered in standardized forms by persons or processes, such that entry of a given data element in a given field in a given form may be mapped or correlated to one or more descriptors of categories. Elements in training data may be linked to descriptors of categories or types by tags, tokens, or other data elements. For example, and without limitation, training data may be provided in fixed-length formats, formats linking positions of data to categories such as comma-separated value (CSV) formats and/or self-describing formats such as extensible markup language (XML), enabling processes or devices to detect categories of data.

Alternatively, or additionally, the training data may include one or more data elements that are not categorized, that is, the training data may not be formatted or contain descriptors for some elements of data. Machine-learning models or algorithms and/or other processes may sort the training data according to one or more categorizations using, for instance, natural language processing algorithms, tokenization, detection of correlated values in raw data and the like. The categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name or other types of data may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data to be made applicable for two or more distinct machine-learning algorithms as described in further detail below. Training data used by the electronic device 300 may correlate any input data as described in this disclosure to any output data as described in this disclosure.

As used herein, the term “small language model” is intended to refer to a machine learning model, such as a natural language processing (NLP) model, that employs a relatively small number of adjustable or tunable parameters. The number of parameters can range from a few to a hundreds of millions of parameters. The parameters can be adjusted or tuned by training the model on training data, which can assign weights to neuronal connections in the model. The weights determine the strength and nature of the connections by minimizing the difference between a predicted output and target values from the training data, thus allowing the model to be suitably configured to handle a specific task.

As used herein, the term “data object” can refer to a location or region of storage that contains a collection of attributes or groups of values that function as an aspect, characteristic, quality, entity, or descriptor of the data object. As such, a data object can be a collection of one or more data points that create meaning as a whole. One example of a data object is a data table, but a data object can also be data arrays, pointers, records, files, sets, and scalar type of data.

As used herein, the term “attribute” or “data attribute” is generally intended to mean or refer to the characteristic, properties or data that describes an aspect of a data object or other data. The attribute can hence refer to a quality or characteristic that defines a person, group, or data objects. The properties can define the type of data entity. The attributes can include a naming attribute, a descriptive attribute, and/or a referential attribute. The naming attribute can name an instance of a data object. The descriptive attribute can be used to describe the characteristics or features or the relationship with the data object. The referential attribute can be used to formalize binary and associative relationships and in referring to another instance of the attribute or data object stored at another location (e.g., in another table). When used in connection with prompts for use with a generative language model, the term is further defined below.

The term “application” or “software application” or “program” as used herein is intended to include or designate any type of procedural software application and associated software code which can be called or can call other such procedural calls or that can communicate with a user interface or access a data store. The software application can also include called functions, procedures, and/or methods.

The term “graphical user interface” or “user interface” as used herein refers to any software application or program, which is used to present data to an operator or end user via any selected hardware device, including a display screen, or which is used to acquire data from an operator or end user for display on the display screen. The interface can be a series or system of interactive visual components that can be executed by suitable software. The user interface can hence include screens, windows, frames, panes, forms, reports, pages, buttons, icons, objects, menus, tab elements, and other types of graphical elements that convey or display information, execute commands, and represent actions that can be taken by the user. The objects can remain static or can change or vary when the user interacts with them.

As used herein, the term “electronic device” can include servers, controllers, processors, computers including client devices, tablets, storage devices, databases, memory elements and the like. The electronic device can include processors, memory, storage, display devices, and the like.

The governance system of the present invention enables an enterprise to harness the power of artificial intelligence (AI) while ensuring data privacy and minimizing and preventing data breaches and data leaks. The governance system can be deployed as a Software as a Service (SaaS) solution and is intended for enterprises to protect sensitive and confidential information from exposure to commercial AI tools and products that are used by employees.

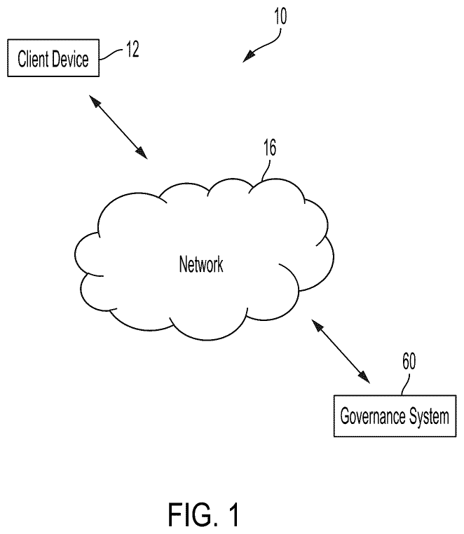

FIG. 1 is a data flow diagram illustrating a networked system 10 that enables a user via a suitable electronic device 12 to communicate and exchange information with a governance system 60 via a network 16. The client device can be any suitable electronic device, such as a computing device, that allows the user to access, interact with, and exchange data with the governance system 60. The network 16 can be any suitable network, such as a local area network (LAN), a wide area network (WAN), a metropolitan area network (MAN), a campus area network (CAN), a storage area network (SAN), a virtual private network (VPN), a wireless local area network (WLAN), or a home area network (HAN), that includes one or more electronic devices, such as one or more servers and other types of computing devices. The illustrated networked system 10 allows for a user to provide prompts and other types of data via the client device, and over the network 16, that can then be processed by the governance system 60. The governance system 60 as described herein can be configured to process the client or user data, identify any confidential information in the user data, and then can, based on user preferences, redact or mask the confidential information. For the sake of simplicity, a single user client device 12 is shown. Those of ordinary skill in the art will readily recognize that multiple client devices can be employed in the networked system 10.

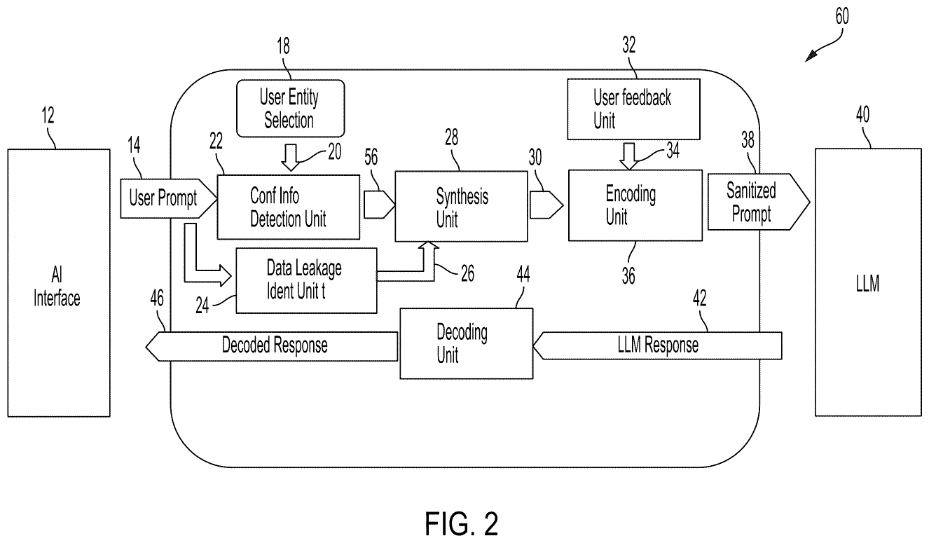

FIG. 2 illustrates the details of the governance system 60 for allowing an enterprise to automatically identify and protect confidential information generated or stored within the enterprise. The client device 12 can include a user interface generator for generating one or more user interfaces that enables or allows a user to provide data in the form of files or raw data or instructions to the governance system 60 via one or prompts 14. Alternatively, the user can provide instructions (e.g., a preset number of configuration options or features) through the interface of the client device 12. The options, for each user or user group, depends on the initial established configurations of the system. The governance system 60 can also include a user entity selection unit 18 for prompting the user to specify a type or specific instance of confidential information (e.g., entity) that the user desires to protect. The entity can be selected from a predetermined list of entities. The entity list can encompass a range of types of confidential information, such as, by simple way of example, names, addresses, zip codes, social security numbers, credit card numbers, email addresses, URLs, dates and times, driver's license numbers, passport numbers, nationalities, medical license numbers, PO Box information, bank account information, IP addresses, API keys, reference numbers, salary information, and the like. The user entity selection unit 18 can generate entity data 20. The user entity selection unit can be a separate unit or can form part of the client device 12.

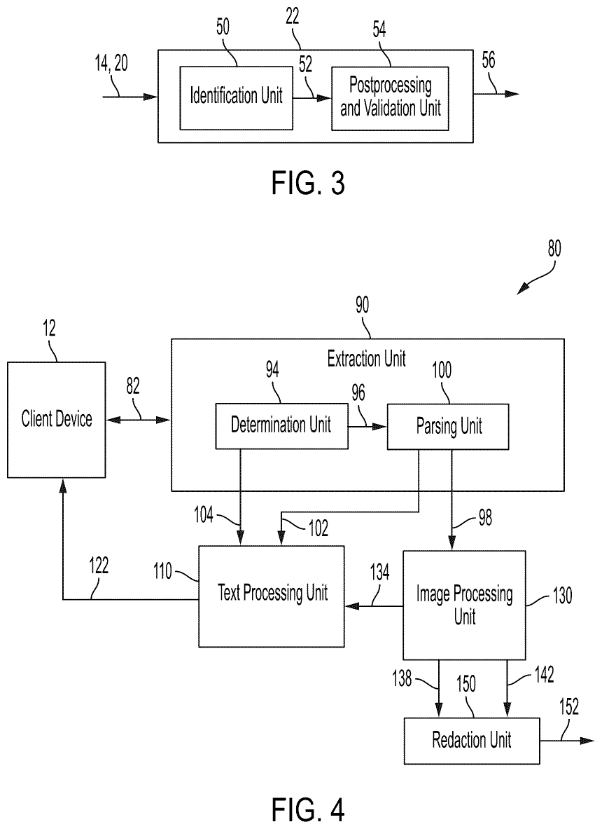

As shown in FIGS. 2 and 3, the entity data 20 and the user input data 14 can be conveyed to and processed by a confidential information detection unit 22. The confidential information detection unit 22 can employ an identification unit 50 for applying a machine learning model, such as a natural language processing model or data extraction technique, to the received user data 14 (e.g., files and raw data) and the entity data 20 to detect the selected entities (e.g., data types) in the user prompt data 14. The data types can include text data, image data, metadata, and the like. For each entity or data type identified in the user data 14, the identification unit 50 (e.g., NLP model) can determine the type of entity and can generate a confidence score 52. According to one embodiment, the identification unit 50 can employ a contextual confidentiality detection model and one or more pattern matching algorithms to provide the confidence score 52. The contextual confidentiality detector model can make the decision regarding what words belong to what category based on a contextual understanding of the provided user data 14. The pattern matching can be employed for validation purposes and for the entity types that the model can identify. The identification unit 50 in essence can assess the reliability, accuracy, and quality of the entity type data and generate a confidence value or score 52 indicative of the accuracy of the data. The confidence score can be optionally compared with a threshold confidence score, and if the determined confidence score is greater than the threshold confidence score or value, then the confidence score is passed along for further processing by the system 10. The identification unit 50 can employ a selected data pattern analysis technique, such as for example a regular expression technique and/or a checksum technique, to identify patterns in the entity type data. For example, the regular expression technique (e.g., regex) can be employed to perform pattern matching within data strings of the data. The regular expression technique defines and locates specific patterns in the data. For instance, passport numbers typically follow a format of two uppercase letters followed by six numbers or digits, thus making the regular expression technique a valuable tool for identifying this type of pattern in the data. In addition to adhering to a specific data pattern, valid IDs for example may also incorporate mathematical relationships between digits, known as a checksum technique. The checksum technique is in essence an error-checking technique and can, for example, add a calculated value to the original input data. The calculated value can be used to check the integrity of the received data and to determine if any errors exist in the transmitted data. When the checksum calculation aligns with the expected value of the data, then the data is valid. Otherwise, it indicates a potential error.

Upon identifying an entry in the entity type data, the identification unit 50 assigns a base confidence score to the data. The confidence score can be contingent on the uniqueness and exclusivity of the identified pattern, providing a systematic approach to validating and scoring potential data entities. For example, a string of 16 digits (possibly separated into groups of 4 digits) has a higher chance of belonging to the category “credit card number” compared to a string of 12 digits belonging to the category “bank account number”, and hence having a higher confidence score. In addition to the base confidence score, the identification unit can increase the detection confidence based on the surrounding words in the data string. For example, if the identification unit 50 determines that the previously mentioned 12-digit string is surrounded by bank-related words, then the identification unit 50 can increase the base confidence score to develop an enhanced confidence score by a calculated or predetermined amount. Further, the identification unit 50 can consider the context provided by the surrounding data string (e.g., words). For example, if the identified 12-digit string is located within the context of bank-related words, then the confidence score determination unit 54 can further increase the enhanced confidence score by a further specific amount. This methodology employed by the confidence score determination unit 54 leverages the contextual information in the data to enhance the reliability of the overall data identification process. The confidence score 52 can be conveyed to a postprocessing and validation unit 54 so as to validate the detected entity and the surrounding related content, and apply selected post-processing techniques that add contextual information and format information to the confidence score. The postprocessing and validation unit 54 can generate an updated confidence score 56 that includes the confidence score and the foregoing additional data.

As shown in FIG. 2, the illustrated governance system 60 can also include a data leakage identification unit 24 for receiving the user prompt data 14. The data leakage identification unit 24 identifies whether the user data 14 includes or is related to specific types of confidential information, such as, by simple way of example, software code and selected types of business information, such as contract information. The data leakage identification unit 24 identifies the presence of these types of confidential information in the prompt data 14 and then requests the user to confirm whether the user wishes to proceed with the data submission, recognizing that the content is confidential, regardless of the specific entities involved. If the user chooses to proceed, then the data leakage identification unit 24 identifies or detects the types of entities contained within the user prompt data 14. According to one practice, the data leakage identification unit 24 can apply a classification technique, such as a logistic regression model, to identify whether the identified entity in the user prompt data 14 belongs to one or more selected categories of confidential data. The logistic regression model can be trained or pretrained on specific types of training data, such as for example on training data associated with software code and contract language that would be deemed to be confidential information. Specifically, the logistic regression model can be trained on a diverse dataset consisting of text paragraphs encompassing code snippets, contract pages, and general news articles. The data leakage identification unit 24 then generates category data 26.

The category data 26 and the confidence score data 56 is then received and processed by a synthesis unit 28. The illustrated synthesis unit 28 processes the input data and then replaces the confidential information (e.g., data entities) with synthetic alternatives that serve as substitutes to the data entities identified in the category data 26 and the confidence score data 56 as relating to confidential information or can be configured to mark or redact the identified confidential data. The synthetic alternatives correspond to artificially generated data that serves as a substitute for the categorized entities (e.g., confidential information). For example, if the name “Joseph Walker” is detected in the category data 26, the synthesis unit 28 replaces the name with a synthetic alternative, such as with a randomly generated name like “David Johnson”. The synthesis unit 28 handles both the substitution of the original entity with the proposed synthetic entity to ensure that the categorized entity, corresponding to the original input prompt data and confidence score data, is not revealed or exposed. The synthesis unit 28 can also be configured to revert the data back to the original entity data by removing the synthetic alternatives. The synthesis unit 28 can employ a data anonymization technique, a privacy-preserving machine learning technique, or generative machine learning models to generate the synthetic data. The synthesis unit 28 ensures that the original data entities remain securely on the user device, while still yielding the same outcome as if the user had submitted the original confidential information. By further way of example, for entities such as names, the synthetic name can be generated by the synthesis unit 28 by selecting a random entity from a predefined pool or list of names. In the case of date/time/day entities, a random date/time/day can be generated by the synthesis unit 28. For other entities such as passport numbers, the synthesis unit 28 can introduce random changes to both numbers and letters. For example, an original passport number such as A12345678 can be substituted with Z97090667, while maintaining the same format as the original data. The synthesis unit 28 can then generate synthetic data 30.

The governance system 10 can further include a user feedback unit 32 that allows the user to decide how to handle the synthetic data 30. For example, the user has the option to either utilize the generated synthetic data 30, request that new synthetic data be generated, or, if the user has the requisite access permission level, the user can override the synthetic data 30 and proceed with the original entity data (e.g., category data 26). The user feedback unit 32 generates decision data 34. The user feedback unit 32 can form part of the client device 12.

The governance system 60 also includes an encoding unit 36 for receiving and processing the decision data 34 and the synthetic data 30. The encoding unit 36 can replace the entity data with the synthetic data when the decision data requests the data replacement. The encoding unit 36 can then generate encoded data 38 that corresponds to a sanitized prompt devoid of any confidential information. Additionally, the encoding unit 36 maintains a secure record of the one-to-one correspondence between the original and synthetic entities, which is needed for the subsequent decoding stage. The encoded data 38 can be conveyed to a machine learning model 40, such as a large language model, for further processing so as to generate model data 42. The LLM model can be any selected machine learning tool that the user can interact with, such as chatbots, text generative models, conversational agents, and the like. For example, the user prompt can start with “write a response to this email indicating . . . ” followed by the email the user has received. Then the synthetic data 30 (e.g., sanitized prompt) can include the same request, except that the confidential information in the email body is replaced with synthetic data. Then the LLM can generate a response to the email/prompt in the form of model data 42, except that some of the synthetic entities appear in the response, making it not usable for the user in that form.

The governance system 60 further includes a decoding unit 44 for receiving and processing the model data 42 and for decoding the model data 42 to form decoded response data 46. The decoding unit 44 can turn the model data 42 into a user ready response. When the LLM 40 generates the model data 42 in response to the synthetic data, the LLM 40 can include some of the synthetic entities, rendering the result unsuitable for direct use by the user. The governance system 10 can transform the model data 42 with the decoding unit 44 into the decoded response data 46. The decoding unit 44 can decode the synthetic data in the model data 42 by reverting the synthetic entity back to the original entity data form. The decoding is done by using an encoding table employed by the encoding unit 36. There is a one-to-one correspondence between the original data entities provided by the user and the synthetic entities generated by the synthesis unit 28 and confirmed by the user via the user feedback unit 32 and contained within the decision data 34. The decoding unit 44 can then generate decoded data 46 that is representative or indicative of the original user prompt data 14. The final decoded response is then prepared for immediate use by the user, eliminating the need for any further adjustments.

In the governance system 60, one or more of the confidential information detection unit 22, the data leakage identification unit 24, the synthesis unit 28, the encoding unit 36 and the decoding unit 44 can employ a small language model. The small language model can employ the NLP training and learnings to identify confidential data (default and/or selected) in the prompt data and flag or mark the confidential data for encoding/scrambling/masking and the like. Subsequently, the small language model can identify the encoded material when the prompt is returned and decode/unscramble/unmask the encoded data.

The small language model can be configured to specialize in confidentiality information such as personal information, financial information, health data, usernames, passwords, API keys, proprietary codes, data types, and metadata attributes. In case of any confidential data risk, the user receives a notification before the query is submitted to an AI/LLM solution. Once the synthesis unit 28 identifies the confidential information, the entity data can be replaced with the synthetic alternatives. Further, the data can be encrypted using known data encryption techniques, such as via AES-256-bit encryption or scrambles the data through interpolation, shuffling, tokenization, and the like, making the data operable with machine learning models. The governance system can be implemented as an engine on the user device, such that the original and encoded data never leaves the user's device.

The governance system 60 of the present invention provides for selected advantages. For example, the governance system 60 can be implemented as a web-based solution (e.g., a SaaS solution), or can be an on-premises solution for seamlessly passing encoded or masked data to the LLM 40. The governance system 60 can also unmask the data (e.g., model data) based on a user selection or preference. From there on, the AI-generated final prompt content is updated with the actual prompt data on the user-facing interface via the client device 12. The governance system 60 also automatically detects and protects confidential information contained with the user prompt.

The present invention addresses the challenges of detecting, identifying, and manipulating (e.g., securing) confidential information in any data processing system that is responsible for processing textual information and the commonly utilized file types by providing a complete AI or ML driven governance framework and system.

Another embodiment of the governance system of the present invention is shown for example in FIG. 4. The illustrated governance system 80 enables a user, via the client device 12, to input into the governance system 80 any selected type of input data 82. The input data can include prompt data, which in turn can include text data and document data. The input data 82 may also include confidential information. The input data 82 is then received and processed by a data extraction unit 90. The data extraction unit 90 can employ a data extraction engine to process the input data 82 to determine the type of data in the input data 82 and to parse the input data 82 into selected constituent data entities or components. The data can have selected attributes associated therewith. Specifically, the illustrated data extraction unit 90 can include a determination unit 94 that is configured to receive the input data 82 and to determine the type of data within the input data 82. If the input data includes document data, for example, then the determination unit 94 determines the presence of the document data and then provides the document data 96 to a data parsing unit 100. The data parsing unit 100 can be configured to employ a parsing engine to parse or break down the document data 96 into constituent data types or components, such as text data, image data, and metadata, as well as document format and structure information, and the like. The parsing unit 100 can then convey the extracted text data 102 to a text processing unit 110.

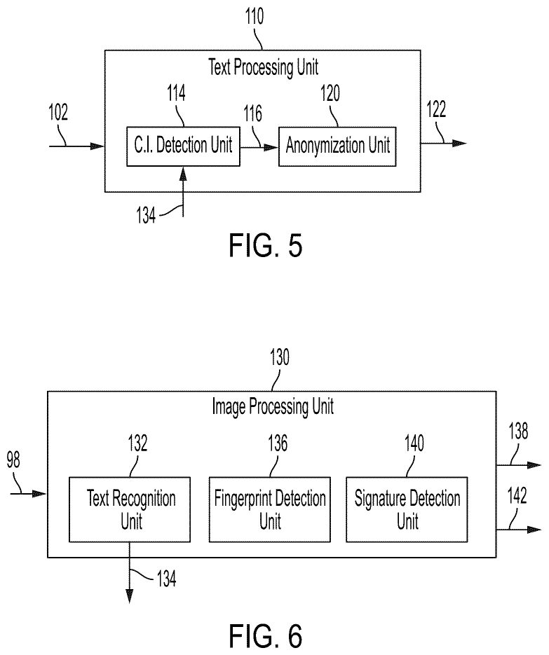

As shown in FIGS. 4 and 5, the text processing unit 110 can employ a text processing engine for processing the extracted text data 102. The text processing unit 110 can identify and detect confidential information that may be present in the extracted text data 102. Specifically, the text processing unit 110 can include a confidential information detection unit 114 for receiving and processing the extracted text data 102 and for identifying confidential information therein. The confidential information detection unit 114 can identify and tag the confidential information that is determined to be present within the text data. The confidential information detection unit 114 can employ a first machine learning model, such as a transformer type model (e.g., a natural language processing model), to identify and select, such as by tagging, the confidential information resident within the text data. The confidential information detection unit 114 can ensure that confidential information, such as identifiable or known confidential information and unidentifiable or unknown confidential data, such as contextually hidden confidential data, are both successfully identified. The identifiable or known confidential information can refer to information or data elements that can directly identify an individual or enterprise or sensitive attribute about the individual or enterprise, either on their own or when combined with other accessible information. Examples include explicit identifiers (e.g., name, social security number, and the like), quasi-identifiers including demographic data (e.g., gender, age, zip code, and the like), and other related easily discernible information. The contextually hidden confidential information can refer to sensitive or confidential data that remains concealed or is implicit within the context of the data or the processing of the data. For example, the metadata associated with the input data 82 can include information that purposely or inadvertently reveals confidential details or information about the user or the system. The contextually hidden confidential information can be identified by applying a second transformer-type machine learning model that is trained on a suitable dataset of typical confidential information and the like. The second transformer model thus identifies contextually hidden confidential information. The use of the machine learning models to identify or detect both types of confidential information provides for a dual-layered identification approach. The confidential information identified by the second transformer type model can be further postprocessed by one or more machine learning models or by a model analysis or explainability technique, such as for example by a hierarchical recursive segment analysis (HRSA) technique. The HRSA technique is a data analysis technique that can be used to postprocess data to uncover relationships therein. The HRSA technique adopts a structured approach to data processing that organizes the data into a hierarchy and then recursively processes or divides the data segments into ever smaller data subunits to find meaningful patterns or insights therein. The HRSA technique can organize the data into a hierarchical, multi-level framework where each level represents different “segments” or categories of data. The data hierarchy enables deeper, more granular analysis of the data by analyzing data t each level and identifying relationships that only appear when viewed at specific levels. The recursive portion of the technique involves segmenting or breaking down the data segments in a repeated (recursive) manner, until the data is divided into its smallest, most meaningful data subunits. The recursive segmentation of the data allows the system to analyze how factors interact across various levels or layers, thus making it possible to identify nuanced trends in the data. For the input data (e.g., user prompt data, user data, document extracted data, text data, image data, and the like), the HRSA model can be applied as an over-layer to the results of the second transformer type model of the confidential information detection unit 114. The HRSA technique offers transparency by identifying which parts of the model data contribute most to model decisions regarding confidentiality and then are extracted from the model data. The expected types of confidential information refers to categories of sensitive or confidential information that are typically present and may require protection. The expected types of confidential information can include, for example, healthcare data, financial data, personally identifiable information, protected health information, employment information, social security number, name, address data, and the like. The confidential information detection unit 114 can then generate output data (e.g., detected confidential data) that includes the confidential data identified in the extracted text data 102 as well as contextually hidden confidential information. The HRSA technique also extracts data from the model data that contributes the most to the decisions of the model. The confidential information detection unit 114 thus generates detected confidential data 116 that includes confidential information and extracted data (from the HRSA technique) that contributes the most to the decisions of the model. The detected confidential data 116 can then be passed through an optional text anonymization unit 120 that receives and processes the detected confidential information 116 and then selectively anonymizes the confidential information contained within the extracted text data 102. The text anonymization unit 120 can anonymize the confidential portions of the text data (e.g., the detected confidential data 116) using one or more types of machine learning models so as to anonymize the data. As used herein, the term “anonymize” can refer to the ability to remove, mask, obscure, redact, replace (such as with synthetic data), highlight, or transform the confidential information in the text data in such a manner that a system or someone could not otherwise infer, identify, or reveal the anonymized confidential information while maintaining the text's utility for analysis or for subsequent tasks. Examples of suitable machine learning models employed by the confidential information detection unit 114 can include for example named entity recognition (NER) models, regular expression (Regex) models, text classification models, and the like. The NER model can utilize selected datasets, a transformer model developed and trained on the dataset, and postprocessing algorithms to detect confidential information. The contextual analysis can employ a transformer-type model that is trained on selected relative datasets and postprocessed by the HRSA technique. The HRSA technique offers transparency by identifying which parts of the input data contribute most to model decisions regarding confidentiality. The machine learning models employed by the text anonymization unit 120 can be trained to identify specific types of confidential information in the data entities or expressions in the text data, such as names, locations, social security numbers, phone numbers, and the like. The data entities or expressions are representative of the confidential information. Alternatively, the text anonymization unit 120 can employ a machine learning model that can be trained to classify whether or not the text data contains confidential information. The text anonymization unit 120 can then generate anonymized text data 122.

With reference to FIGS. 4 and 6, the illustrated governance system 80 can also include an image processing unit 130 for processing extracted image data. The parsing unit 100, in addition to the text data, can also extract image data from the input document data 96 to form extracted image data 98. The extracted image data 98 is then received and processed by an image processing unit 130. The image processing unit 130 can employ a text recognition unit for processing the extracted image data 98. The text recognition unit 132 can employ an optical character recognition (OCR) engine for extracting text data from the extracted image data 98 and then converting the text data into suitable visual formats. The text recognition unit 132 can then generate recognized text data 134. The recognized text data 134 can be conveyed to the text processing unit 110, and specifically to the confidential information detection unit 114 to determine if confidential information resides in the recognized text data 134. The image processing unit 130 can also employ an optional fingerprint detection unit 134 for receiving and analyzing the extracted text data 98 and identifying any fingerprint information that may reside in the image data. The fingerprint detection unit 134 can generate fingerprint data 138. Similarly, the image processing unit 130 can employ an optional signature detection unit 140 for identifying signature information that may reside in the extracted image data 98. The signature detection unit 140 can generate signature data 142. The fingerprint detection unit 136 and the signature detection unit 140 each can employ one or more machine learning models or techniques for identifying fingerprint and signature information in the image data. For example, one or more supervised learning techniques can be employed to recognize patterns in signatures and/or fingerprints. The supervised learning techniques can include a convoluted neural network (CNNs), support vector machines (SVMs), K-nearest neighbor (KNN) technique, and the like. Further or optionally, one or more unsupervised learning models or techniques can be employed when there are no labeled datasets available, and the system is configured to discover hidden patterns or groupings in the image data. The unsupervised learning models can include one or more clustering algorithms (e.g., K-means or Density-Based Spatial Clustering of Applications with Noise (DBSCAN)) or one or more autoencoder techniques. Further or optionally, one or more semi-supervised techniques, ensemble learning techniques (e.g., random forest or gradient boosting machines (GBM)), or reinforcement learning techniques can be employed. According to one embodiment, the fingerprint detection unit 136 and the signature detection unit 140 can employ a hybrid machine learning model that employs a convolutional neural network (CNN) backbone employed for feature extraction and a transformer-type model for decision making based on the extracted image features.

The fingerprint data 138 and the signature data 142 can then be forwarded to a redaction unit 150 for anonymizing (e.g., redacting) the fingerprint and signature data, which are identified as confidential information, from the image data. According to one embodiment, the redaction unit 150 can permanently remove or mask the confidential information from the image data, thus making the data relatively inaccessible. The confidential information can also be hidden or redacted from the document, thus preventing data from being viewed or accessed by unauthorized users. For example, names, credit card numbers, addresses, and the like, are removed from the document, leaving blacked-out or blank space areas in place of the redacted confidential information. The redacted data 152 generated by the redaction unit 150 can be safely shared or stored without revealing any of the original confidential information. Alternatively, similar to the text anonymization unit 120, the confidential information can be anonymized so as to mask, highlight, hide, or obfuscate the confidential information while maintaining the text's utility for analysis or for subsequent tasks.

The text anonymization unit 120 can be configured to anonymize the confidential information, where the detected confidential information or data is replaced with other types of data, such as synthetic or generalized alternatives. For instance, the name “John Doe” can be replaced with “Individual A,” and a specific address can be replaced with a generalized location such as “City Center.” This ensures that the data retains its structure and readability but loses any link to identifiable confidential entities. Anonymization is commonly applied in medical records or customer feedback, where maintaining the flow of information without exposing personal details is important. The text anonymization unit 120 can also employ one or more synthetic replacement: techniques for generating synthetic alternatives for detected confidential information (e.g., data entities), which can include replacing names with randomly generated names, such as changing “Alice Smith” to “Jane Brown,” or altering numbers while maintaining the original format, such as replacing a passport number “A12345678” with “Z97090667.” The synthetic data is then used in subsequent processing to preserve privacy while maintaining data integrity. Synthetic replacement allows for the use of realistic but non-identifiable data, ensuring compliance with data privacy regulations, such as GDPR. The combination of redaction, anonymization, and synthetic replacement ensures flexibility in how confidential information is detected and managed, allowing enterprises to adapt their data protection strategy based on specific use cases and privacy requirements. For example, in a corporate environment, financial reports may need redaction, employee records may require anonymization, while customer feedback data used for training machine learning models may benefit from synthetic replacement.

With reference again to FIGS. 4 and 5, if the determination unit 94 determines that the input data 82 contains text data 104, then the text data 104 can be conveyed to the text processing unit 110 rather than to the parsing unit 100. The text processing unit 110 can process the text data 104 in a manner similar to the extracted text data 102. Specifically, the confidential information detection unit 114 can analyze the text data 104 to detect the presence of confidential information. If confidential information is discovered, then the confidential information can be conveyed to the anonymization unit 120 for processing thereby.

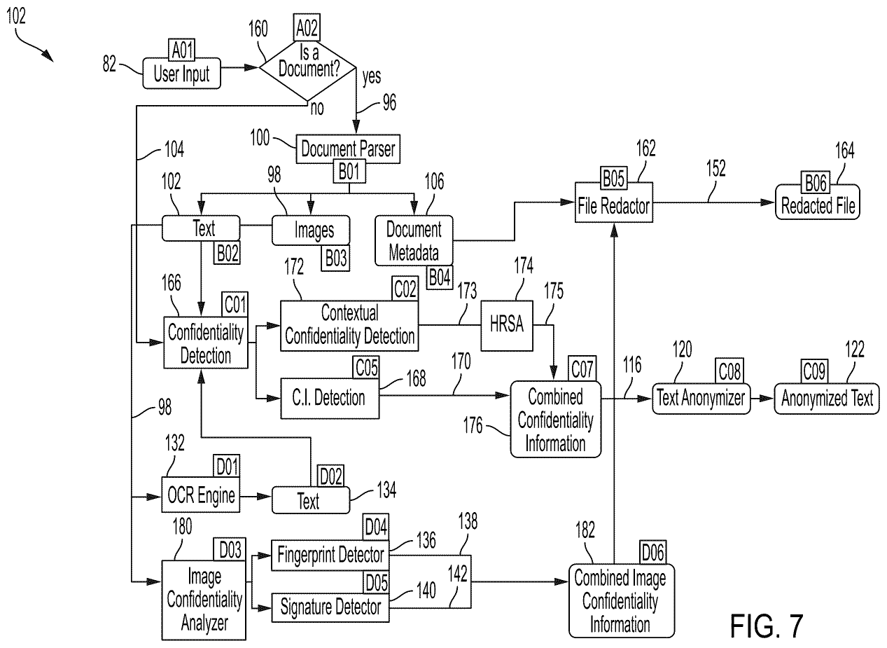

FIG. 7 is a schematic flow chart diagram illustrating the flow of data when being processed by the governance system 80 of the present invention. The data flow tags (A01, A02, B01, B02, C01, C02, D01, D02, and the like) simply indicate, from a visual perspective, the data processing pipelines employed by the data governance system of the present invention. The user can employ the client device 12 to generate, collate or submit the input data 82 into the governance system 80. The input data 82 can include any type of data, including any combination of text data and document data, that may or may not include confidential information. The input data 82 is conveyed to the data extraction unit 90. The data extraction unit 90 can employ the data determination unit 94 that determines if the input data includes text data and/or document data, step 160. The governance system 80 ingests the user input, which can include either a document file or plain text, and the type of data is determined and the data determination unit 94 directs the data to the appropriate data processing pipeline, namely, either a document parsing data pipeline or a text processing data pipeline. Specifically, if the input data 82 includes document data 96, then the document data 96 is conveyed to the parsing unit 100 where the document data 96 is parsed. The parsing unit 100 can parse the document data 96 into extracted text data 102, extracted image data 98, and extracted metadata 106. The extracted metadata 106 can be passed through the anonymization or redaction unit 150, where the metadata can be anonymized, such as by being redacted, step 162. The redaction unit 150 can generate redacted data 152, step 164.

The extracted text data 102, which is extracted from the document data 96, can be conveyed to the text processing unit 110, which includes the confidential information detection unit 114 for detecting the presence of confidential information in the extracted text data 102 and the anonymization unit 120 for anonymizing the confidential information present within the extracted text data 102. The extracted text data 102 is conveyed to a confidential information detector (e.g., detection unit 114), step 166, forming the text processing data pipeline or engine. The confidential information detection unit 114 detects confidential information that may reside or be present in the extracted text data 102. For example, the extracted text data 102 can be processed by a first machine learning model, such as a natural language processing model or a NER model, that can be used to identify and select (or tag) the known or identifiable confidential information within the data 102, step 168. The first model then generates first model data (identified confidential information data) that can include the confidential information 170. Further, the extracted text data 102 can be conveyed to and processed by a second and separate machine learning model to detect or identify any contextually hidden confidential information in the data, step, 172. The contextually hidden confidential information can be identified by applying a second machine learning model to the data that identifies confidential information in the text data 102. The second machine learning model can generate second model data 173. The second model data 173 can then be processed by the HRSA technique 174. The HRSA technique processes and identifies specific parts of the model data 173 that contribute the most to the model's confidentiality determination decision. The detection of contextual confidential information adds an additional layer to the confidential information detection methodology of the detection unit 114 by evaluating the contextual confidentiality information that may reside within the extracted text data 102. This additional detection process ensures that both known or identifiable confidential information and unknown contextually hidden, confidential information are successfully identified. The identified or known confidential information 170 and the identified contextual confidential information 175 can be combined, step 176, to form the confidential information 116 generated by the confidential information detection unit 114. The confidential information 116 can be optionally conveyed to the text anonymization unit 120 that is configured to receive and process the detected confidential information 116 and then selectively anonymize the confidential information contained therein. The text anonymization unit 120 can anonymize the confidential portions of the text data (e.g., the detected confidential data 116) using one or more types of machine learning models so as to remove, mask, redact, highlight, or obfuscate the confidential information while maintaining the text's utility for analysis or for subsequent tasks. The text anonymization unit 120 can then generate the anonymized textual data 122.

The extracted image data 98 can be conveyed to an image data processing engine for processing the image data. The image data 98 can be passed through the text recognition unit 132, which can employ an OCR engine, in order to further extract text data that may reside in the image data 98. The further extracted text data forms the recognized text data 134. The recognized text data 134 can be conveyed to the confidential information detection unit 114 for further processing in the manner previously described. The extracted image data 98 can also be analyzed, step 180, and optionally conveyed to one or more of the fingerprint detection unit 136 for detecting any fingerprint information or data 138 that may be present within the extracted image data 98 and the signature detection unit 140 for detecting any signature information or data 142 that may be present within the extracted image data 98. The fingerprint data 138 and the signature data 142 can be optionally combined, step 182, and then conveyed to the redaction unit 150. The redaction unit 150 can be employed to anonymize the confidential information within the data.

The text data portion 104 of the input data 82. as determined by the determination unit 94, can be conveyed directly to the text processing unit 110, and specifically to the confidential information detection unit 114, for determining if confidential information resides in the text data 104, step 166. Further, the image processing unit 130, the text processing unit 110, and the redaction unit 150 can generate output data in any selected type or form. According to one embodiment, the resulting data can be a data file that can then be converted into a desired, output terminal document format or manifest file. The machine learning models employed by one or more of the text processing unit 110, image processing unit 130, confidential image detection unit 114, text anonymization unit 120, text recognition unit 132, fingerprint detection unit 136, signature detection unit 140, and redaction unit, can employ a small language model.

The text anonymization unit 120 and the redaction unit 150 can be used to anonymize the confidential portions of the input data 82 using one or more types of machine learning models so as to remove, mask, redact, replace, highlight, or obfuscate the confidential information while maintaining the text's utility for analysis or for subsequent tasks. For example, the text or image data can be redacted, ensuring that the original data is no longer visible or accessible. For example, names, credit card numbers, or addresses can be removed from the data (e.g., document data) leaving blacked-out or blank areas in place of the confidential information. The redacted output data can be safely shared or stored without revealing any of the original confidential information. The text or image data can be anonymized, where the detected data is replaced with synthetic or generalized alternatives. For example, the name “John Doe” can be replaced with “Individual A,” and a specific address can be replaced with a generalized location such as “City Center.” This anonymization process ensures that the data retains its structure and readability but loses any link to identifiable entities. The anonymization of data can be applied in medical records or customer feedback, where maintaining the flow of information without exposing personal details is desired. Still further, the confidential information in the text or image data can be replaced with synthetic alternatives by the text anonymization unit 120 or the redaction unit 150. For example, the synthetic alternatives can include replacing names with randomly generated names, such as changing “Alice Smith” to “Jane Brown,” or altering numbers while maintaining the original format, such as replacing a passport number “A12345678” with “Z97090667.” The synthetic or replacement data can then be used in subsequent processing to preserve privacy while maintaining data integrity. Synthetic replacement is especially useful in training the machine learning models, since it allows the use of realistic but non-identifiable data, ensuring compliance with data privacy regulations.

The machine learning models, such as the models employed by the confidential information detection unit 114, can be trained on curated or selected training data to ensure high accuracy, reliability, and compliance with industry standards. For example, the models can be trained on a diverse range of training data sources, including proprietary data generated by partners, synthetic data generated through advanced prompt engineering techniques using generative models, publicly available data, data from competitions and contests, and the like. The synthetic data can be optionally post-processed and validated by human annotators with domain expertise. The validation methodology allows the governance system 80 to use dynamically training datasets for continuously improving model accuracy and enhancing the ability to recognize data entities (e.g., confidential information) that are typically missed by generic off-the-shelf machine learning models. The machine learning model used to identify contextual confidential information can employ a binary classification approach to distinguish between confidential and non-confidential data. The training dataset can cover various domains, such as sales, finance, health, customer support, and research and development, thus ensuring broad applicability. Training samples can be generated using large language models, followed by validation by human annotators to handle potentially unseen or complex cases. The training process can include hyperparameter tuning utilizing techniques such as quantization, pruning, and knowledge distillation to optimize model performance. Further, to make the natural language processing (NLP) models more efficient, the governance system 80 can utilize knowledge distillation, where a large complex model (e.g., teacher model) is trained to accurately model the dataset. The output of the teacher model is then used to train a smaller, more compact model (e.g., student model) that maintains equivalent performance but is computationally more efficient. The machine learning models can be optimized for on-device inference, allowing the models to run efficiently on low-resource devices. For example, the transformer-based NER model can contain approximately 50 million parameters and can be optimized for real-time inference on consumer-grade hardware, ensuring sub-0.15-second latency without relying on GPU resources.

According to another embodiment, one or more of the fingerprint detection unit 136 and the signature detection unit 140 can employ an object detection model that can be trained on a diverse dataset comprising synthetic and real-world images. The dataset can include high-quality images sourced from public databases, partner-provided data, and synthetic samples that simulate real-world conditions. Human annotators with domain expertise can optionally be involved in the labeling process, ensuring that the dataset covers different scenarios, including variations in image quality, background complexity, and object overlap. The object detection models can be based on a deformable transformer (DETR) architecture, such as the DETR model. The DETR model eliminates the need for anchor boxes, simplifying the training process and making the models more efficient in handling complex images. By way of example, the DETR model can employ a transformer encoder-decoder structure, where the encoder processes input images to generate feature maps, and the decoder predicts object bounding boxes and class labels. This approach allows for better generalization across different image types and reduces the computational burden associated with traditional object detection pipelines. The DETR model can be configured to enhance model precision and reduce inference time, specifically for document images used in data governance scenarios. The DETR models can be trained using a combination of synthetic and real-world image datasets, with data augmentation techniques such as random cropping, flipping, and color adjustments to improve generalization capabilities. The object detection models can be deployed using Docker containers, enabling secure, scalable integration into client environments. Optimized versions of the models allow for real-time object detection on devices with limited computational resources. For example, hybrid CNN-transformer architecture provides a balanced approach to local feature extraction and global context understanding, ensuring high-fidelity detection even in challenging visual environments.

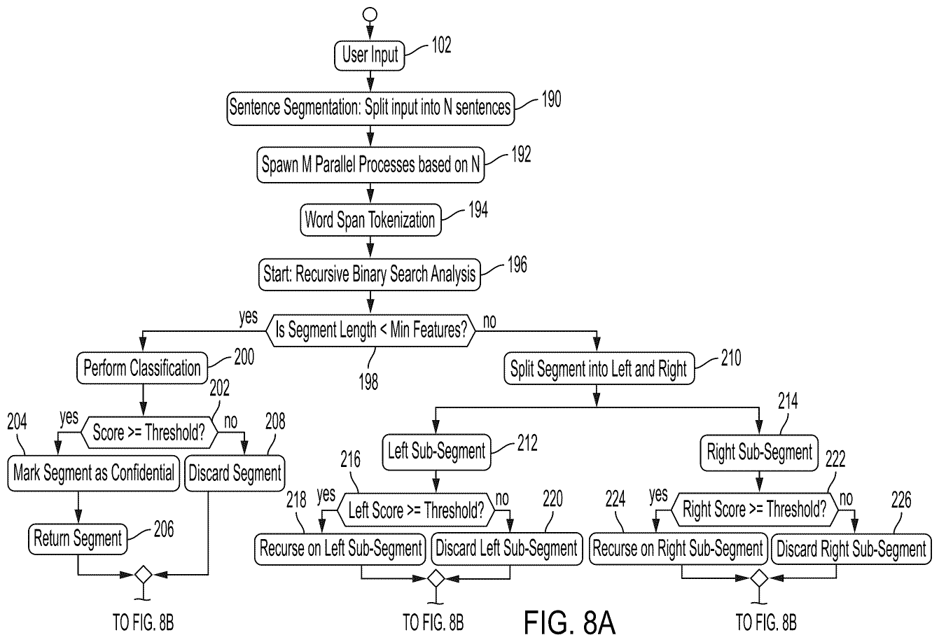

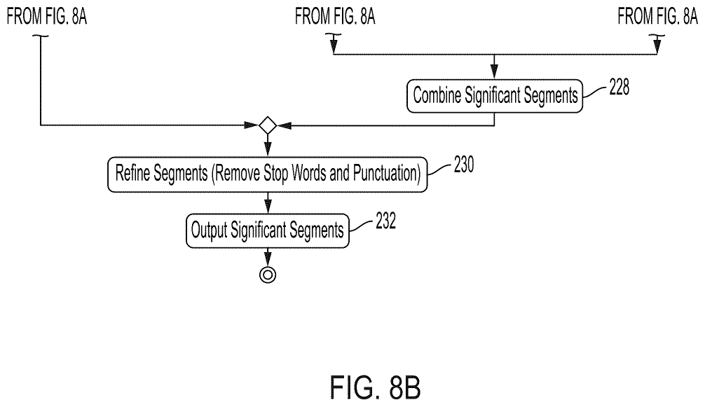

The confidential information detection unit 114 of the governance system 80 can employ an HRSA technique for processing the contextually hidden confidential information identified by a machine learning model and identifying the most contextually significant parts of the model data that contribute to the model's decision-making process (e.g., identification of confidential information). This detailed segmentation and evaluation provide transparency when determining the presence of confidential information in the text data. An example of a suitable HRSA technique is schematically shown for example, in data flow form, in FIGS. 8A and 8B. The input text data 102, 104 can be processed by the HRSA technique of the present invention. The HRSA technique can break down the input text 102, 104 into selected data segments, for example, such as by initially splitting or breaking down the data into sentences and subsequently into word-level spans, step 190. This hierarchical segmentation helps provide a detailed understanding of which specific parts of the text are contributing to the confidentiality assessment made by the machine learning model. The HRSA technique can employ a recursive binary search function that systematically divides text segments into smaller sub-segments. Each segment can be classified based on a pre-determined threshold value, which represents the model's confidence in labeling the segment as “confidential.” The recursive nature of the analysis allows the HRSA technique to identify or determine the significant portions of the text while discarding or ignoring those portion of the text deemed to be less relevant. The data segments that meet or exceed the threshold are retained and further processed by the HRSA technique. To enhance the granularity of the analysis, the HRSA technique can utilize a refinement step that removes stop words and punctuation, ensuring that only the most contextually relevant data is analyzed. This refinement helps eliminate noise and focuses on the key information that led to the confidentiality determination. By recursively analyzing and refining the data segments, the HRSA technique provides a clear explanation of why certain parts of the text were identified and flagged as confidential. The iterative approach ensures that only the most influential words and phrases are retained, offering users a transparent view of the model's decision-making process.

More specifically, the model data when segmented into N sentences also generates N parallel processes to process the sentences, step 192. The model can then break down the sentences and other text data into meaningful segments (e.g., spans) that represent selected words or phrases, step 194. This segmentation process helps the HRSA model analyze textual data hierarchically, thus helping identify patterns or segments within the text at different levels of granularity. The HRSA technique can then apply a recursive binary search function or technique to the segmented data, step 196. The recursive binary search technique helps identify segments or clusters of data within the hierarchical data segments by repeatedly dividing the data in a binary (e.g., two-part) manner. This additional segmentation approach combines elements of recursive binary search with hierarchical segmentation, allowing the HRSA technique to detect and organize complex text patterns within large datasets. The binary data split can occur based on one or more selected data attributes or features that differentiates the data from each other. The HRSA technique then compares the data segment length to a minimum feature length, step 198. The segment length comparison to a minimum feature length helps determine if a data segment includes enough relevant data or features to continue further segmentation or analysis. This analysis or check helps ensure that the data segments meet a minimum standard of information content, ensuring that the analysis remains meaningful and interpretable. If the data segment is less than a threshold feature, then the HRSA technique can classify the data segments, step 200, by using a classification technique to label or categorize the data segments. The classification can include a confidential information classification. The classification technique can include, for example, a logistic regression, decision tree, or neural network, to generate a classification score, which can be a probability or confidence score indicative of the confidence that the data segment belongs to a particular class. In the current embodiment, the score can be indicative of whether the data segment includes confidential information. The score reflects the likelihood that the data segment fits into a specific classification based on the features available within the data segment. The classification (e.g., confidence) score can then be compared to a threshold score, step 202. If the classification score is above the threshold score, then the data segment is marked as or determined to include confidential information, step 204. Once classified, the classified data segment can be made available for further processing or returned by the HRSA technique, step 206. If the classification score is less than a defined threshold, then the data segment is ignored or discarded as not containing confidential information, step 208.

The HRSA technique can define or set a threshold to guide the HRSA technique when to stop further data segmentation. The threshold can be set or based on selected criteria, such as minimum data segment length (e.g., number of items in a group), similarity scores (e.g., level of homogeneity within a segment), statistical measures such as variance or entropy, and the like. The step of determining data segment length relative to a threshold helps identify patterns or segments within the data and helps the model decide when a data segment is sufficiently refined or homogeneous, relative to the threshold, before the model stops further data segmentation. The threshold thus helps prevent over-segmentation, which can lead to data segments that are either too small or insignificant to yield meaningful insights.

When the segment length is greater than the minimum feature number or length, then the HRSA technique can further segment the data segment into sub-segments, step 210. According to one embodiment, the data segment can be segmented into a left data segment (e.g., sub-segment), step 212, and a right data segment (e.g., sub-segment), step 214. The data segments can be divided based on selected criteria, such as feature or threshold values. The data segments can also be indicative of a determination of whether the data segments meet selected criteria. For example, the left and right data segments can include data points that meet or fail to meet a specific condition or criterion set during the segmentation process. The left data segment can then be compared to a threshold value to determine if the segment score (e.g., classification or confidence score) meets or exceeds the threshold score, which can be indicative of a certain level of quality, significance, or relevance of the data segment, step 216. If the classification or confidence score is greater than the threshold score, then the HRSA technique recurses the data segment, step 218. Specifically, for each data segment or subsegment, the HRSA technique performs an analysis and then recurses the data segment by further subdividing the segment into further subsegments. The HRSA technique repeats the analysis on the smaller subsegments, allowing the model to explore hierarchical relationships within the data. If the score is less than the threshold score, then the HRSA technique can discard or ignore the data segment, since no meaningful information is retained therein, step 220. The same process is followed on the right data subsegment. The right data segment can be compared to a threshold value to determine if the right segment score (e.g., classification or confidence score) meets or exceeds the threshold score, which can be indicative of a certain level of quality, significance, or relevance of the data segment, step 222. If the classification or confidence score is greater than the threshold score, then the HRSA technique recurses the data segment, step 224. Specifically, for each data segment or subsegment, the HRSA model performs an analysis and then recurses the data segment by further subdividing the segment into further subsegments. The HRSA technique repeats the analysis on the smaller subsegments, allowing the model to explore hierarchical relationships within the data. If the score is less than the threshold score, then the HRSA technique can discard or ignore the data segment, since no meaningful information is retained therein, step 226. The model can then combine the significant right and left data segments, step 228, ands then refine the data segments, step 230. The HRSA technique can refine the data segments by cleaning and preprocessing the data segments. The cleaning process can include removing stop words, eliminating punctuation, standardizing text, or filtering out irrelevant data to refine the data segments to make them more meaningful and structured for the analysis process. The data segment refinement process improves the ability of the HRSA technique to detect selected patterns and relationships within each data segment. The HRSA technique then outputs the refined data in the form of significant segments, step 232. The significant segments are portions of the data hierarchy that reveal or include meaningful patterns, trends, or anomalies, and often highlight insights that impact decision-making.

It is to be understood that although the present invention has been described above in terms of particular embodiments, the foregoing embodiments are provided as illustrative only, and do not limit or define the scope of the invention. Various other embodiments, including but not limited to those described herein, are also within the scope of the claims. For example, elements, units, engines, tools and components described herein may be further divided into additional components or joined together to form fewer components for performing the same functions. Further, the above-described windows or screens or the reference or inference to display or user interfaces can be generated by any selected portion or unit of the governance system 10, 80. The governance system can also employ any selected portion or unit of the system to generate user interfaces or suitable reports, for display on the display 370.

Any of the functions disclosed herein may be implemented using means for performing those functions. Such means include, but are not limited to, any of the components disclosed herein, such as the electronic or computing device components described herein.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

The term computing device or electronic device or computer, and which can be used to implement any portion of the governance system, can refer to any device that includes a processor and a computer-readable memory capable of storing computer-readable instructions, and in which the processor is capable of executing the computer-readable instructions in the memory. The terms computer system and computing system if referenced herein refer to a system containing one or more computing devices.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention may operate on digital electronic processes which can only be created, stored, modified, processed, and transmitted by computing devices and other electronic devices. Such embodiments, therefore, address problems which are inherently computer-related and solve such problems using computer technology in ways which could not be solved manually or mentally by humans.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claimed herein which recites that the claimed method is performed or implemented by a computer, a processor, a memory, and/or similar computer-related element, is intended to, and should only be interpreted to, encompass methods which are performed by the recited computer-related element(s) or components. Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Embodiments of the present invention solve one or more problems that are inherently rooted in computer technology. For example, embodiments of the present invention solve the problem of how to use a data governance system to automatically identify and if desired highlight confidential information in text and document data. There is no analog to this problem in the non-computer environment, nor is there an analog to the solutions disclosed herein in the non-computer environment.

Furthermore, embodiments of the present invention represent improvements to computer and communication technology itself. For example, the governance system of the present invention can optionally employ a specially programmed or special purpose computer in an improved computer system, which may, for example, be implemented within a single computing device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements can also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

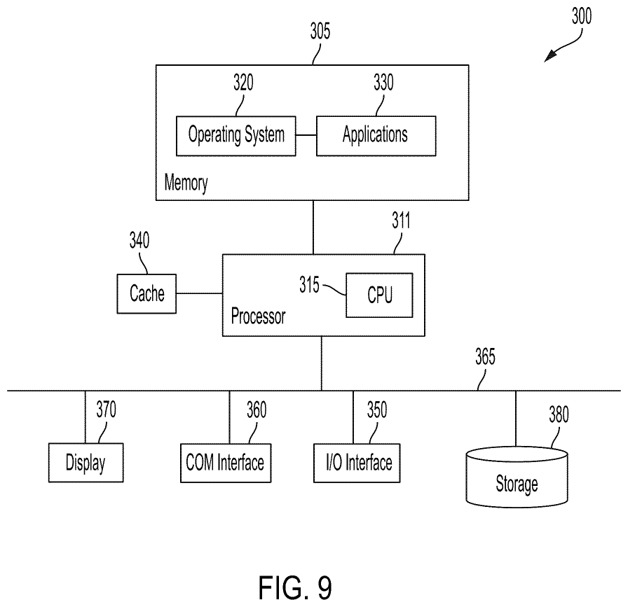

It should be appreciated that various concepts, systems and methods described above can be implemented in any number of ways, as the disclosed concepts are not limited to any particular manner of implementation or system configuration. Examples of specific implementations and applications and the exemplary hardware shown in FIG. 9 are primarily for illustrative purposes and for providing or describing the operating environment of the system of the present invention or the hardware that can be employed to implement the system. The governance system 10, 80 and/or any elements, components, or units thereof can employ one or more electronic or computing devices, such as one or more servers, clients, computers, laptops, smartphones and the like, that are networked together or which are arranged so as to effectively communicate with each other. The network can be any type or form of network. The devices can be on the same network or on different networks. In some embodiments, the network system may include multiple, logically grouped servers. In one of these embodiments, the logical group of servers may be referred to as a server farm or a machine farm. In another of these embodiments, the servers may be geographically dispersed. The electronic devices can communicate through wired connections or through wireless connections. The clients can also be generally referred to as local machines, clients, client nodes, client machines, client computers, client devices, endpoints, or endpoint nodes. The servers can also be referred to herein as servers, server nodes, or remote machines. In some embodiments, a client has the capacity to function as both a client or client node seeking access to resources provided by a server or server node and as a server providing access to hosted resources for other clients. The clients can be any suitable electronic or computing device, including for example, a computer, a server, a smartphone, a smart electronic pad, a portable computer, and the like, such as the electronic or computing device 400. The present invention can employ one or more of the illustrated computing devices and can form a computing system. Further, the server may be a file server, application server, web server, proxy server, appliance, network appliance, gateway, gateway server, virtualization server, deployment server, SSL VPN server, or firewall, or any other suitable electronic or computing device, such as the electronic device 300. In one embodiment, the server may be referred to as a remote machine or a node. In another embodiment, a plurality of nodes may be in the path between any two communicating servers or clients. The governance system 10, 80 can be stored on one or more of the clients or servers, and the hardware associated with the client or server, such as the processor or CPU and memory described below.

### Exemplary Hardware

It should be appreciated that various concepts introduced above and discussed in greater detail below may be implemented in any number of ways, as the disclosed concepts are not limited to any particular manner of implementation or system configuration. Examples of specific implementations and applications are provided below primarily for illustrative purposes and for providing or describing the operating environment of the system of the present invention. The governance system 80 of the present invention can employ a plurality of electronic devices, such as one or more servers, clients, computers and the like, that are networked together, or which are arranged so as to effectively communicate with each other. The network can be any type or form of network. The devices can be on the same network or on different networks. In some embodiments, the network system may include multiple, logically grouped servers. In one of these embodiments, the logical group of servers may be referred to as a server farm or a machine farm. In another of these embodiments, the servers may be geographically dispersed. The devices can communicate through wired connections or through wireless connections. The clients can also be generally referred to as local machines, clients, client nodes, client machines, client computers, client devices, endpoints, or endpoint nodes. The servers can also be referred to herein as servers, nodes, or remote machines. In some embodiments, a client has the capacity to function as both a client or client node seeking access to resources provided by a server or node and as a server providing access to hosted resources for other clients. The clients can be any suitable electronic or computing device, including for example, a computer, a server, a smartphone, a smart electronic pad, a portable computer, and the like, such as the electronic device 300. Further, the server may be a file server, application server, web server, proxy server, appliance, network appliance, gateway, gateway server, virtualization server, deployment server, SSL VPN server, or firewall, or any other suitable electronic or computing device, such as the electronic device 300. In one embodiment, the server may be referred to as a remote machine or a node. In another embodiment, a plurality of nodes may be in the path between any two communicating servers or clients. The governance system 80 of the present invention can be stored on one or more of the clients, servers, and the hardware associated with the client or server, such as the processor or CPU and memory described below.

FIG. 9 is a high-level block diagram of an electronic device 300 that can be used with the embodiments disclosed herein. Without limitation, the hardware, software, and techniques described herein can be implemented in digital electronic circuitry or in computer hardware that executes firmware, software, or combinations thereof. The implementation can be as a computer program product (e.g., a non-transitory computer program tangibly embodied in a machine-readable storage device, for execution by, or to control the operation of, one or more data processing apparatuses, such as a programmable processor, one or more computers, one or more servers and the like).

The illustrated electronic device 300 can be any suitable electronic circuitry that includes a main memory unit 305 that is connected to a processor 311 having a CPU 315 and a cache unit 340 configured to store copies of the data from the most frequently used main memory 305.

Further, the methods and procedures for carrying out the methods disclosed herein can be performed by one or more programmable processors executing a computer program to perform functions of the invention by operating on input data and generating output. Further, the methods and procedures disclosed herein can also be performed by, and the apparatus disclosed herein can be implemented as, special purpose logic circuitry, such as a FPGA (field programmable gate array) or an ASIC (application specific integrated circuit). Modules and units disclosed herein can also refer to portions of the computer program and/or the processor/special circuitry that implements that functionality.

The processor 311 is any logic circuitry that responds to, processes, or manipulates instructions received from the main memory unit, and can be any suitable processor for execution of a computer program. For example, the processor 311 can be a general and/or special purpose microprocessor and/or a processor of a digital computer. The CPU 315 can be any suitable processing unit known in the art. For example, the CPU 315 can be a general and/or special purpose microprocessor, such as an application-specific instruction set processor, graphics processing unit, physics processing unit, digital signal processor, image processor, coprocessor, floating-point processor, network processor, and/or any other suitable processor that can be used in a digital computing circuitry. Alternatively or additionally, the processor can comprise at least one of a multi-core processor and a front-end processor. Generally, the processor 311 can be embodied in any suitable manner. For example, the processor 311 can be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. Additionally or alternatively, the processor 311 can be configured to execute instructions stored in the memory 305 or otherwise accessible to the processor 311. As such, whether configured by hardware or software methods, or by a combination thereof, the processor 311 can represent an entity (e.g., physically embodied in circuitry) capable of performing operations according to embodiments disclosed herein while configured accordingly. Thus, for example, when the processor 311 is embodied as an ASIC, FPGA or the like, the processor 311 can be specifically configured hardware for conducting the operations described herein. Alternatively, as another example, when the processor 311 is embodied as an executor of software instructions, the instructions can specifically configure the processor 311 to perform the operations described herein. In many embodiments, the central processing unit 530 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The processor can be configured to receive and execute instructions received from the main memory 305. The processor or CPU can also include a graphical processing unit (GPU), which is a specialized processor that is configured to handle and accelerate the rendering of images, animations, and videos. Initially developed to improve graphics performance in gaming and visual applications, GPUs are now widely used for various types of parallel processing, especially in fields of artificial intelligence (AI), machine learning, and scientific computations. Examples of suitable GPUs include the A100, H100, A40, V100, T4, LA, RTX 30 series, RTX 40 series, RTX A series, and Titan RTX GPUs from Nvidia, and the Instinct MI100, Instinct MI200 series, Instinct MI300, Radeon RX 6000 series, Radeon RX 7000 series, Radeon Pro W7000 series, and Radeon Pro W6000 series GPUs from Advanced Micro Devices (AMD).

The electronic device 300 applicable to the hardware of the present invention can be based on any of these processors, or any other processor capable of operating as described herein. The central processing unit 315 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i3, INTEL CORE i5, INTEL CORE i7, INTEL CORE i9, and INTEL CORE X.

The processor 311 and the CPU 315 can be configured to receive instructions and data from the main memory 305 (e.g., a read-only memory or a random access memory or both) and execute the instructions. The instructions and other data can be stored in the main memory 305. The processor 311 and the main memory 305 can be included in or supplemented by special purpose logic circuitry. The main memory unit 305 can include one or more memory chips capable of storing data and allowing any storage location to be directly accessed by the processor 311. The main memory unit 305 may be volatile and faster than other memory in the electronic device, or can dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 305 may be non-volatile, e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 305 can be based on any of the above described memory chips, or any other available memory chips capable of operating as described herein. In the embodiment shown in FIG. 9, the processor 311 communicates with main memory 305 via a system bus 365. The computer executable instructions of the present invention may be provided using any computer-readable media that is accessible by the computing or electronic device 300. Computer-readable media may include, for example, the computer memory or storage unit 305. The computer storage media may also include, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer readable storage media does not include communication media. Therefore, a computer storage or memory medium should not be interpreted to be a propagating signal per se or stated another transitory in nature. The propagated signals may be present in a computer storage media, but propagated signals per se are not examples of computer storage media, which is intended to be non-transitory. Although the computer memory or storage unit 305 is shown within the computing device 300 it will be appreciated that the storage may be distributed or located remotely and accessed via a network or other communication link.

The main memory 305 can comprise an operating system 320 that is configured to implement various operating system functions. For example, the operating system 320 can be responsible for controlling access to various devices, memory management, and/or implementing various functions of the asset management system disclosed herein. Generally, the operating system 320 can be any suitable system software that can manage computer hardware and software resources and provide common services for computer programs.

The main memory 305 can also hold application software 330. For example, the main memory 305 and application software 330 can include various computer executable instructions, application software, and data structures, such as computer executable instructions and data structures that implement various aspects of the embodiments described herein. For example, the main memory 305 and application software 330 can include computer executable instructions, application software, and data structures, such as computer executable instructions and data structures that implement various aspects of the content characterization systems disclosed herein, such as processing and capture of information. Generally, the functions performed by the content characterization systems disclosed herein can be implemented in digital electronic circuitry or in computer hardware that executes software, firmware, or combinations thereof. The implementation can be as a computer program product (e.g., a computer program tangibly embodied in a non-transitory machine-readable storage device) for execution by or to control the operation of a data processing apparatus (e.g., a computer, a programmable processor, or multiple computers). Generally, the program codes that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be configured to be executed on a computer, or on multiple computers, at one site or distributed across multiple sites and interconnected by a communications network, such as the Internet.

The processor 311 can further be coupled to a database or data storage 380. The data storage 380 can be configured to store information and data relating to various functions and operations of the content characterization systems disclosed herein. For example, as detailed above, the data storage 380 can store information including but not limited to captured information, multimedia, processed information, and characterized content.

A wide variety of I/O devices may be present in or connected to the electronic device 300. For example, the device can include a display 370. The display 370 can be configured to display information and instructions received from the processor 311. Further, the display 370 can generally be any suitable display available in the art, for example a Liquid Crystal Display (LCD), a light emitting diode (LED) display, digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays, or electronic papers (e-ink) displays. Furthermore, the display 370 can be a smart and/or touch sensitive display that can receive instructions from a user and forwarded the received information to the processor 311. The input devices can also include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output devices can also include video displays, graphical displays, speakers, headphones, inkjet printers, laser printers, and 3D printers.

The electronic device 300 can also include an Input/Output (I/O) interface 350 that is configured to connect the processor 311 to various interfaces via an input/output (I/O) device interface 380. The device 300 can also include a communications interface 360 that is responsible for providing the circuitry 300 with a connection to a communications network (e.g., communications network 120). Transmission and reception of data and instructions can occur over the communications network.

We claim:

1. A computer-implemented method for identifying and anonymizing confidential information in input data, the method performed by at least one computer processor executing computer-readable instructions tangibly stored on at least one computer-readable medium, the method comprising the steps of:
extracting one or more of textual data and document data from the input data, wherein the document data includes one or more of second textual data and image data,
processing the textual data and the second textual data to identify the confidential information therein,
anonymizing the confidential information,
processing the image data to identify image-based confidential information therein, and
anonymizing the image-based confidential information.

2. The computer-implemented method of claim 1, wherein the step of extracting comprises
determining whether the textual data or the document data forms part of the input data, and
parsing with a parsing engine the document data into the second textual data and the image data.

3. The computer-implemented method of claim 2, wherein the step of processing the textual data and the document data comprises
detecting and identifying the confidential information in the textual data and the second textual data, and
anonymizing the confidential information.

4. The computer-implemented method of claim 3, wherein the confidential information includes identifiable confidential information and contextually hidden confidential information, wherein the step of detecting and identifying comprises applying a first machine learning model to the confidential information to identify the identifiable confidential information.

5. The computer-implemented method of claim 3, wherein the step of detecting further comprises applying a second machine learning model to the textual data and the second textual data for identifying the contextually hidden confidential information therein, wherein the second machine learning model generates second model data that includes the contextually hidden confidential information.

6. The computer-implemented method of claim 5, wherein the step of detecting further comprises applying a hierarchical recursive segment analysis technique to the second model data for identifying in the contextually hidden confidential information data that contributes the most to the decisions of the second machine learning model.

7. The computer-implemented method of claim 6, wherein the step of anonymizing the confidential information comprises applying a third machine learning model to the confidential information to anonymize the confidential information.

8. The computer-implemented method of claim 7, wherein the third machine learning model comprises a named entity recognition (NER) model, a regular expression (Regex) model, or a text classification model.

9. The computer-implemented method of claim 7, wherein the step of anonymizing comprises highlighting the confidential information.

10. The computer-implemented method of claim 9, wherein the step of processing the image data comprises processing the image data with an optical character recognition engine for extracting third textual data from the image data and identifying confidential information therein.

11. The computer-implemented method of claim 10, wherein the step of processing the image data further comprises
detecting fingerprint data in the image data, or
detecting signature data in the image data,
wherein the signature data and the fingerprint data form part of the image-based confidential information.

12. The computer-implemented method of claim 11, wherein the step of anonymizing the image-based confidential information comprises redacting the image-based confidential information.

13. The computer-implemented method of claim 12, further comprising anonymizing the confidential information or the image-based confidential information by replacing one or more portions thereof with synthetic data.

14. A system for identifying and anonymizing confidential information in input data, comprising
a data extraction unit for extracting one or more of the textual data and the document data from the input data, wherein the document data includes one or more of second textual data and image data, wherein the data extraction unit includes
a determination unit for determining whether the textual data or the document data forms part of the input data, and
a parsing unit having a parsing engine for parsing the document data into the second textual data and the image data,
a text processing unit having a text processing engine for processing one or more of the textual data and the second textual data and for identifying confidential information therein and for anonymizing the confidential information, wherein the text processing unit includes
a confidential information detection unit employing a first machine learning model configured for detecting and identifying confidential information in the textual data and the second textual data, wherein the confidential information includes identifiable confidential information and contextually hidden confidential information, and
an anonymization unit for selectively anonymizing the confidential information, and
an image processing unit for processing the image data and for identifying image-based confidential information therein.

15. The system of claim 14, wherein the first machine learning model comprises a transformer-type model, including a natural language processing model.

16. The system of claim 15, wherein the confidential information detection unit applies a second machine learning model to the textual data and the second textual data for identifying the contextually hidden confidential information therein, wherein the second machine learning model generates second model data that includes the contextually hidden confidential information.

17. The system of claim 16, wherein the confidential information detection unit further applies a hierarchical recursive segment analysis technique to the second model data for identifying in the contextually hidden confidential information data that contributes the most to the decisions of the second machine learning model.

18. The system of claim 17, wherein the image processing unit comprises a text recognition unit employing an optical character recognition engine for extracting third textual data from the image data, and then processing the third textual data with the confidential information detection unit to identify confidential information in the third textual data.

19. The system of claim 18, wherein the image processing unit further comprises
a fingerprint detection unit for detecting fingerprint data in the image data, or
a signature detection unit for detecting signature data in the image data,
wherein the signature data and the fingerprint data form part of the image-based confidential information.

20. The system of claim 19, further comprising a redaction unit for anonymizing the image-based confidential information.

21. The system of claim 20, wherein the redaction unit is configured to redact the image-based confidential information.

22. The system of claim 20, wherein the anonymization unit or the redaction unit can be configured to replace at least portions of the confidential information and the image-based confidential information with synthetic data.

23. A non-transitory, computer readable medium comprising computer program instructions tangibly stored on the computer readable medium, wherein the computer program instructions are executable by at least one computer processor to perform a method for anonymizing confidential information in input data, the method comprising:
extracting one or more of textual data and document data from the input data, wherein the document data includes one or more of second textual data and image data, including
determining whether the textual data or the document data forms part of the input data, and
parsing with a parsing engine the document data into the second textual data and the image data,
processing the textual data and the second textual data to identify the confidential information therein, including
detecting and identifying, with a transformer-type machine learning model, the confidential information in the textual data and the second textual data, and
anonymizing the confidential information,
processing the image data to identify image-based confidential information therein, and
anonymizing the image-based confidential information.

24. The computer readable medium of claim 23, wherein the confidential information includes identifiable confidential information and contextually hidden confidential information, wherein the step of detecting and identifying comprises
applying a first machine learning model to the confidential information in the textual data and the second textual data for identifying the identifiable confidential information therein,
applying a second machine learning model to the textual data and the second textual data for identifying the contextually hidden confidential information therein, wherein the second machine learning model generates second model data that includes the contextually hidden confidential information, and
applying a hierarchical recursive segment analysis technique to the second model data for identifying in the contextually hidden confidential information data that contributes the most to the decisions of the second machine learning model.

25. The computer readable medium of claim 24, wherein anonymizing the confidential information comprises applying a third machine learning model to the confidential information to anonymize the confidential information.

26. The computer readable medium of claim 25, wherein the third machine learning model includes a named entity recognition (NER) model, a regular expression (Regex) model, or a text classification model.

27. The computer readable medium of claim 26, wherein anonymizing the confidential information comprises highlighting the confidential information.

28. The computer readable medium of claim 27, wherein processing the image data comprises processing the image data with an optical character recognition engine for extracting third textual data from the image data and identifying confidential information therein.

29. The computer readable medium of claim 28, wherein processing the image data further comprises
detecting fingerprint data in the image data, or
detecting signature data in the image data,
wherein the signature data and the fingerprint data form part of the image-based confidential information.

30. The computer readable medium of claim 29, further comprising anonymizing the confidential information or the image-based confidential information by replacing one or more portions thereof with synthetic data.
